(19) United States
(12) Patent Application Publication
(10) Pub. No.: US 2016/0380581 A1
(43) Pub. Date: Dec. 29, 2016

(54) SOLAR PANEL SUPPORT FRAME AND SOLAR POWER DEVICE

(71) Applicant: XSOL CO., LTD., Kyoto-shi (JP)

(72) Inventor: Kazushi Kawakatsu, Kyoto-shi (JP)

(21) Appl. No.: 15/190,596

(22) Filed: Jun. 23, 2016

(30) Foreign Application Priority Data
Jun. 23, 2015 (JP) 2015-125489

(51) Int. Cl. H02S 30/10; H02S 20/24

(52) U.S. Cl. CPC H02S 30/10; H02S 20/24

(57) ABSTRACT

There is provided a non-fix type solar panel support frame and a solar power device having improved resistance property against wind without decreasing workability. In the solar panel support frame, a first rail for supporting an upper end edge of the solar panel is composed of three first rail portions arranged in a lateral direction of the solar panel with gaps. The first rail portion includes: a weight-mounting plate on which a weight is mounted; a windbreak wall extended vertically from the weight-mounting plate for preventing wind from entering a rear surface side with respect to a light-receiving surface of the solar panel; and a panel fixing portion provided on an upper end edge of the windbreak wall.

### TECHNICAL FIELD

This invention relates to a solar panel support frame for installing a plurality of solar panels, and a solar power device having such solar panels.

### BACKGROUND ART

With the heightening concern toward the earth environment, the solar power is focused because it is expected to have an effect of reducing greenhouse gas and the like. Various ways for installing the solar panel on an installation location are conventionally known. In many cases, for supporting the solar panel, a solar panel support frame fixed to the installation location with bolts or the like is used (for example, refer to PTL 1.

Here, in these days, a flat roof such as a top of the building (hereinafter referred to as deck roof) is used for an installation location of the solar panel. As the solar panel support frame used in the installation on the deck roof, a non-fix type solar panel support frame having no fixing structure without bolts or the like is proposed (for example, refer to PTL 2). Such a solar panel support frame is immovably installed on the installation location due to a weight putting down such as a concrete block. Thereby, the fixing work with bolts becomes unnecessary and the installation work of the solar panel is simplified relative to the fix-type solar panel support frame. Further, a process for modifying the deck roof such as drilling the deck roof for a bolt becomes unnecessary, and the deck roof is prevented from being damaged.

### CITATION LIST

### Patent Literature

PTL 1: JP 2008-244219 A
PTL 2: JP 4614668 B

### SUMMARY OF INVENTION

### Technical Problem

Here, there is a problem that the above non-fix type solar panel support frame is, due to the non-fix type, vulnerable to wind blowing into a rear surface of the solar panel compared with the fix-type solar panel support frame. For improving the resistance to wind, it is possible to provide a cover at a position which may be a wind inlet. However, such an installation of the cover may spoil the good workability which the non-fix type solar panel support frame inherently has.

Incidentally, the problem concerning the non-fix type solar panel support frame has been explained so far with a deck roof as an example of the installation location. However, such a problem is not limited to the solar panel support frame installed on the deck roof, and may be generated commonly to the non-fix type solar panel support frame installed on the flat installation location, for example, a part of the outdoor parking lot is used as the installation location of the solar panel.

Accordingly, in view of the above problem, an object of the present invention is to provide a non-fix type solar panel support frame and a solar power device having increased resistance to wind without reducing workability.

### Solution to Problem

For solving the above problem, according to a first aspect of the present invention, there is provided a solar panel support frame for installing a plurality of solar panels each disposed in an inclined pose in an inclination direction relative to a flat installation location, and arranged in an array direction crossing the inclination direction of the solar panel and along the installation location, the solar panel support frame including:
a first rail extending in the array direction and supporting an upper end edge in the inclination direction of the solar panel;
a second rail extending in the array direction and parallel to the first rail, and supporting a lower end edge in the inclination direction of the solar panel; and
a weight installing immovably any one or both of the first and second rails on the installation location due to its weight,
wherein the first rail is made of a plurality of first rail portions arranged in the array direction with a gap shorter than each first rail portion, and each first rail portion is longer than a half width in the array direction of the solar panel, and
wherein the first rail portion includes:
a weight-mounting plate extending along the installation location and on which the weight is mounted;
a windbreak wall extending vertically from the weight-mounting plate and preventing wind from entering a rear surface side relative to a light-receiving surface of the solar panel; and
a panel fixture provided on an upper end edge of the windbreak wall and fixing the upper end edge of the solar panel.

According to a second aspect of the present invention, there is provided the solar panel support frame as described in the first aspect,
wherein the second rail is made of a plurality of second rail portions arranged in the array direction, and each second rail portion is substantially equal to or longer than the half width in the array direction of the solar panel,
wherein a length of the first rail portion is substantially equal to the half width in the array direction of the solar panel, and
wherein each single solar panel is provided with the one first rail portion, and with one or a plurality of the second rail portions.

According to a third aspect of the present invention, there is provided the solar panel support frame as described in the first or second aspect,
wherein the windbreak wall is provided with a cable-arrangement groove as a concave groove opening in an opposite side to the center side of the solar panel seen from the windbreak wall and extending in the array direction, and into which a cable to be connected to the solar panel is allowed to be arranged, and
wherein the cable arranged inside of the cable-arrangement groove is connected to the solar panel in a manner passing through a gap between the first rail portions to reach the rear surface side of the solar panel.

According to a fourth aspect of the present invention, there is provided the solar panel support frame as described in any one of the first to third aspects,
wherein the windbreak wall is provided with a cable-arrangement tube as a tubular portion extending in the array direction and opening at both ends, and into which a cable to be connected to the solar panel is allowed to be arranged, and
wherein the cable arranged inside of the cable-arrangement tube is connected to the solar panel in a manner passing through a gap between the first rail portions to reach the rear surface side of the solar panel.

According to a fifth aspect of the present invention, there is provided a solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame as described in any one of first to fourth aspects.

### Advantageous Effects of Invention

According to the first and fifth aspect of the present invention, the first rail portion supporting the upper end edge in the inclination direction of the solar panel is provided with the windbreak wall preventing wind from entering a rear surface side relative to a light-receiving surface of the solar panel. Thereby, the wind from the upper end edge in the installation direction to the rear surface where particularly the entrance of wind is concerned is prevented from entering. At this time, the windbreak wall blocks a space between the upper end edge in the inclination direction of the solar panel and the first rail. Because the first rail is divided into a plurality of first rail portions, and the solar panel can be installed per each first rail portion, the reduction of workability due to the windbreak wall is minimized. In this way, according to the first and fifth aspect of the present invention, there is provided a non-fix type solar panel support frame and a solar power device having increased resistance to wind without reducing workability.

Further, according to the second aspect of the present invention, because the second rail is also divided to a plurality of second rail portions, the workability of installing the solar panel is further improved.

Further, according to the third aspect of the present invention, a cable-arrangement groove opening in an opposite side to the center side of the solar panel seen from the windbreak wall and extending in the array direction is provided. Thereby, the cable can be installed into the cable-arrangement groove while the cable can be seen. Further, after the installation, the condition of the installed cable can be confirmed visually.

Further, according to the fourth aspect of the present invention, the cable-arrangement tube into which a cable is allowed to be arranged is provided. Thereby, when there is a cable particularly hostile to be exposed to the surrounding environment, such a cable can be insulated from the surrounding environment by arranging the cable inside of the cable-arrangement tube.

### BRIEF DESCRIPTION OF DRAWINGS

FIG. 1 is a perspective view showing a solar power device according to one embodiment of the present invention;

FIG. 2 is a side view of the solar power device shown in FIG. 1;

FIG. 3 is an exploded perspective view of the solar power device shown in FIG. 1;

FIG. 4 is a view showing a cable to be connected to an output terminal of a solar panel;

FIG. 5 is an enlarged view of an area A1 near an upper end edge of the solar panel in FIG. 2;

FIG. 6 is a perspective view showing an upper fixing bracket;

FIG. 7 is an enlarged view of an area A2 near a lower end edge of the solar panel in FIG. 2; and

FIG. 8 is a perspective view showing a lower fixing bracket.

### DESCRIPTION OF EMBODIMENTS

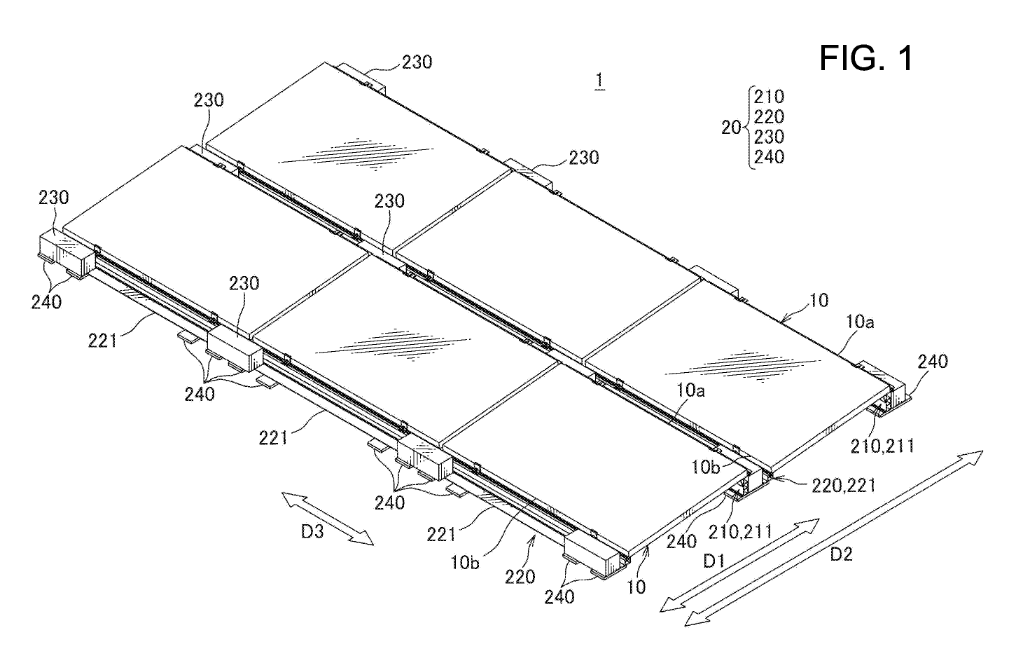

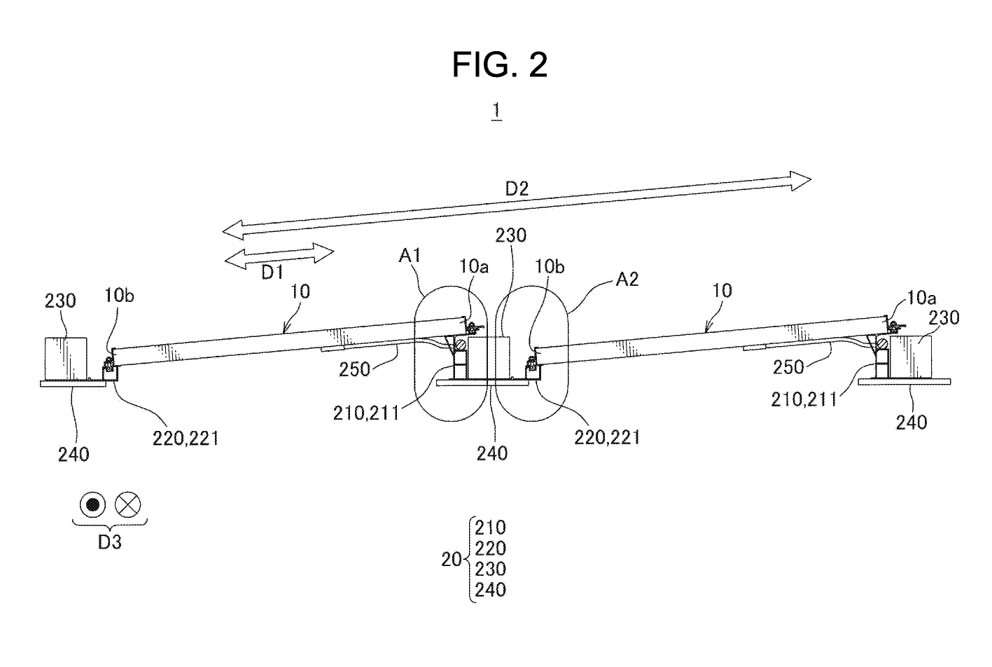

A solar panel support frame and a solar power device according to one embodiment of the present invention will be explained with reference to FIGS. 1 to 8. FIG. 1 is a perspective view showing a solar power device according to one embodiment of the present invention. Further, FIG. 2 is a side view of the solar power device shown in FIG. 1.

A solar power device 1 of this embodiment is installed on a deck roof as a flat roof such as a top of a building. The solar power device 1 includes: six solar panels 10; and a solar panel support frame 20 for installing these six solar panels 10 on the deck roof.

The solar panel support frame 20 supports the solar panel 10 in a manner that the solar panel is inclined relative to the deck roof. Further, the solar panel support frame 20 supports the six solar panels 10 in a manner to arrange two columns in a vertical array direction D2 along an inclination direction D1 of the solar panel 10, and three rows in a lateral array direction D3 crossing the inclination direction D1.

The solar panel support frame 20 includes: a first rail 210; a second rail 220; and a weight 230. The first rail 210 extends in the lateral array direction D3, and supports an upper end edge 10a in the inclination direction D1 of the solar panel 10. The second rail 220 extends in parallel to the first rail 210 and in the lateral array direction D3, and supports a lower end edge 10b in the inclination direction D1 of the solar panel 10. The weight 230 installs immovably the first rail 210 and the second rail 220 on the deck roof due to its weight. Further, the first rail 210 is mounted on a rubber-made non-slip sheet 240 spread on the deck roof.

Here, in this embodiment, the first rail 210 is made of three first rail portions 211 arranged in the lateral array direction D3, and the second rail 220 is also made of three second rail portions 221 arranged in the lateral array direction D3.

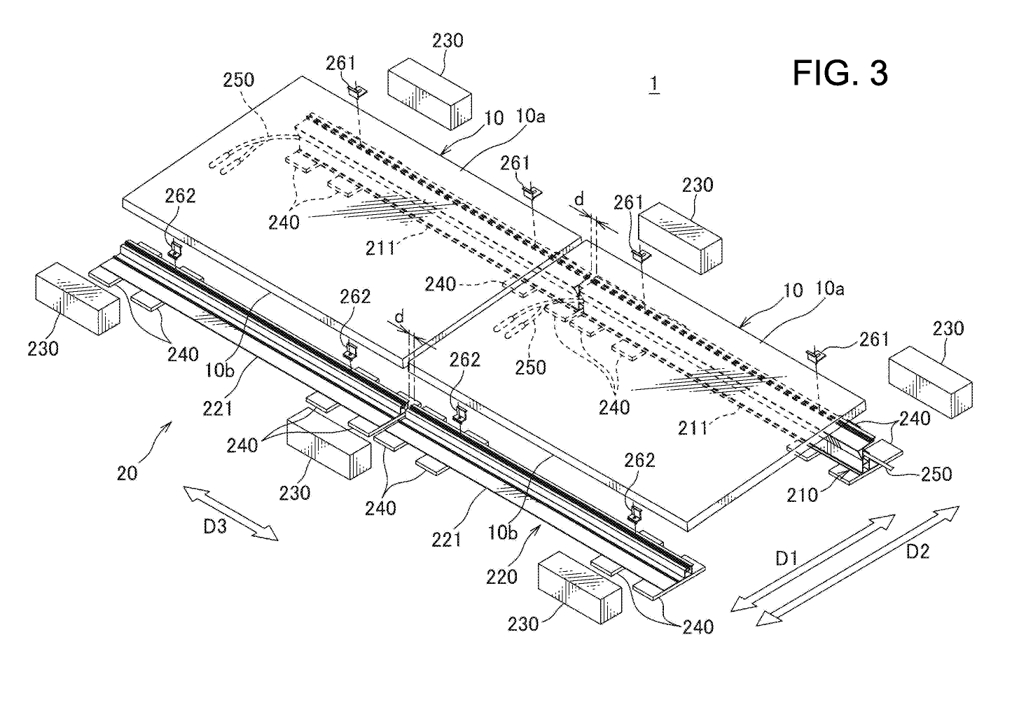

FIG. 3 is an exploded perspective view of the solar power device shown in FIG. 1. In this FIG. 3, the exploded perspective view shows a surrounding structure of two solar panels 10 arranged in the lateral array direction D3 in the solar power device 1.

The first rail portion 211 composing the first rail 210 is longer than a half width in the lateral array direction D3 of the solar panel 10, and in particular, substantially equal to a width of the lateral array direction D3 of the solar panel 10. The second rail portion 221 composing the second rail 220 is substantially equal to or longer than a half width of the lateral array direction D3 of the solar panel 10, and in particular, substantially equal to a width in the lateral array direction D3 of the solar panel 10. The first rail portion 211 and the second rail portion 221 are formed in the mutually same length. Further, per one solar panel 10, the first rail portion 211 composing the first rail 210 and second rail portion 221 composing the second rail 220 are provided one by one.

The first rail portion 211 composing the first rail 210 is longer than a half width in the lateral array direction D3 of the solar panel 10, and in particular, substantially equal to a width of the lateral array direction D3 of the solar panel 10. Similarly, the second rail portion 221 composing the second rail 220 is also substantially equal to or longer than a half width of the lateral array direction D3 of the solar panel 10, and in particular, substantially equal to a width in the lateral array direction D3 of the solar panel 10. The first rail portion 211 and the second rail portion 221 are formed in the mutually same length. Further, per one solar panel 10, the first rail portion 211 composing the first rail 210 and second rail portion 221 composing the second rail 220 are provided one by one.

Three first rail portions 211 are arranged in the lateral array direction D3 with a gap d shorter than the first rail portion 211 to compose the first rail 210. Also, three second rail portions 221 are arranged in the lateral array direction D3 with the same gap d to compose the second rail 220.

The non-slip sheets 240 are spread two by two at both ends of first rail portion 211 and both ends of the second rail portions 221 respectively on the deck roof. Further, the both ends of the first rail portions 211 and the both ends of the second rail portions 221 mounted on the non-slip sheets 240 respectively are installed immovably by the weights 230. The ends adjacent to each other in the lateral array direction D3 of the two first rail portions 211 and the ends of the two second rail portions 221 are respectively installed movably by one weight 230. Further, the first rail portion 211 and the second rail portion 221 adjacent to each other in the vertical array direction D2 are also installed movably by one weight 230.

Here, the first rail portion 211 composing the first rail 210 is provided with a cable 250 to be connected to two pulse and minus output terminals provided on a rear surface of each solar panel 10 as shown in FIGS. 2 and 3.

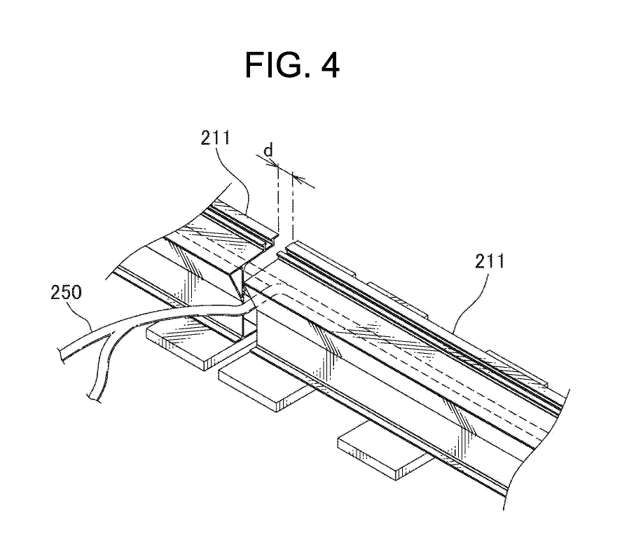

FIG. 4 is a view showing a cable to be connected to an output terminal of a solar panel. As shown in this FIG. 4, the cable 250 installed on the first rail portion 211 extends through a gap d between two adjacent first rail portions 211 toward the rear surface of the solar panel 10. The size of the gap d is wide enough to handle such a cable 250. The cables 250 connected to the output terminals of the solar panels 10 are bundled at the first rail portion 211 side, extended outside from the first rail portion 211 at an end in the lateral array direction D3, and arranged to a not-shown power conditioner provided in a building.

As shown in FIG. 3, the upper end edge 10a in the inclination direction D1 of the solar panel 10 is fixed to the first rail portion 211 with two upper fixing brackets 261, and the lower end edge 10b in the inclination direction D1 is fixed to the second rail portion 221 with two lower fixing brackets 262.

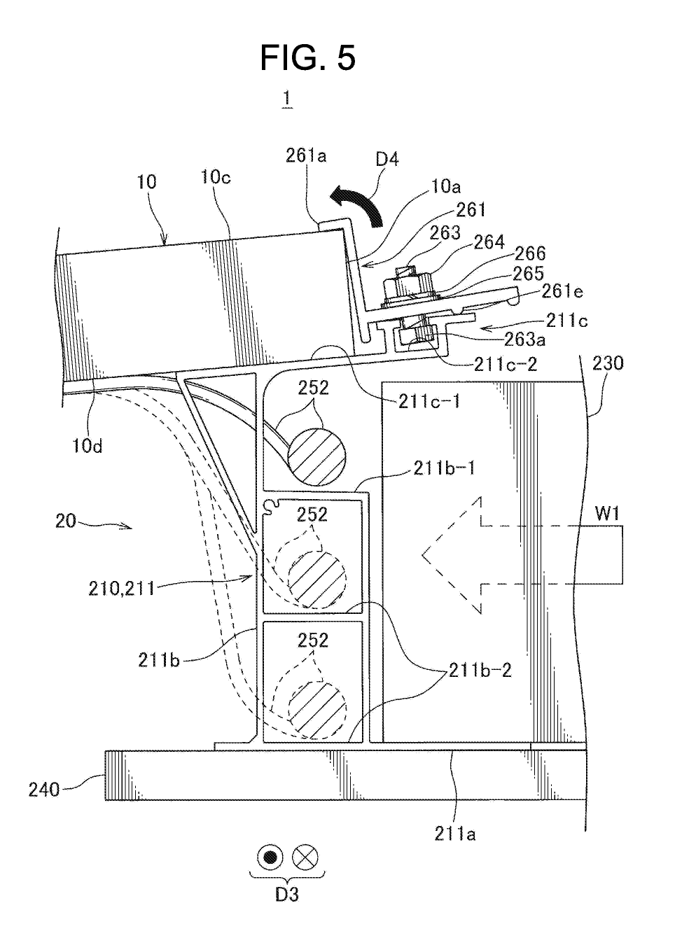

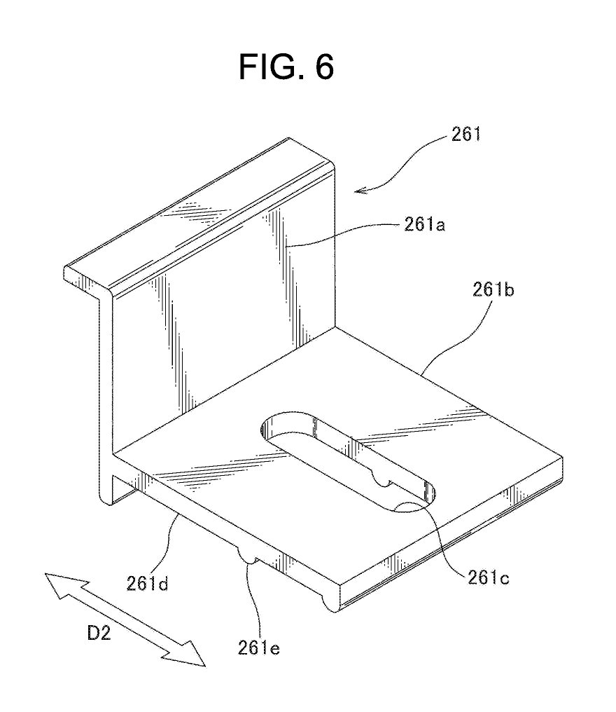

FIG. 5 is an enlarged view of an area A1 near an upper end edge of the solar panel in FIG. 2, and FIG. 6 is a perspective view showing an upper fixing bracket.

As shown in FIG. 5, the first rail portion 211 supporting the upper end edge 10a of the one solar panel 10 includes: a weight-mounting plate 211a; a windbreak wall 211b; and a panel fixture 211c. The weight-mounting plate 211a is put on the non-slip sheet 240 spread on the deck roof, and the weight 230 is mounted on the weight-mounting plate 211a extending along the deck roof. The windbreak wall 211b extends vertically from the weight-mounting plate 211a to prevent wind W1 from entering the rear surface 10d side with respect to the light-receiving surface 10c of the solar panel 10. The panel fixture 211c is provided on an upper end edge of the windbreak wall 211b, and the upper end edge 10a of the solar panel 10 is fixed to the panel fixture 211c with the upper fixing bracket 261.

The panel fixture 211c includes: a mounting surface 211c-1 on which the vicinity of the upper end edge 10a of a rear surface 10d as the installation location side of the solar plate 10 is mounted. This mounting surface 211c-1 is provided with a fixing groove 211c-2 for fixing the upper fixing bracket 261 with a bolt 263 and a nut 264.

The upper fixing bracket 261 fixes the upper end edge 10a of the solar panel 10 to the first rail portion 211 in a manner that the vicinity of the upper end edge 10a is held between the upper fixing bracket 261 and the mounting surface 211c-1 to be fixed to the first rail portion 211. This upper fixing bracket 261 includes: a locking portion 261a and a bracket fixture 261b. The locking portion 261a locks from a side surface to the light-receiving surface 10c side at the upper end edge 10a of the solar panel 10. The bracket fixture 261b extends from the locking portion 261a toward an opposite side of the upper end edge 10a, and is fixed to the panel fixture 211c of the first rail portion 211 with the bolt 263 and the nut 264.

The bracket fixture 261b is provided with an oblong hole 261c extending in the vertical array direction when the upper fixing bracket 261 is attached to the first rail portion 211. As shown in FIG. 5, when the screw head 263a is fitted into the fixing groove 211c-2 of the first rail portion 211, a screw portion of the bolt 263 penetrates the oblong hole 261c. The penetrating screw portion is fastened with the nut 264 via a flat washer 265 and a spring washer 266. Due to this fastening with the nut 264, the bracket fixture 261b, namely, the upper fixing bracket 261 is fixed to the first rail portion 211.

At this time, as shown in FIG. 5, the locking portion 261a is locked on the upper end edge 10a of the solar panel 10. Here, a rear surface 261d, which is a first rail portion 211 side of the bracket fixture 261b, is provide with a projection 261e projecting toward the first rail portion 211. As shown by an arrow D4 in FIG. 5, due to this projection 261e, when the nut 264 is fastened to the bolt 263, the locking portion 261a is inclined toward the mounting surface 211c-1 side centered on a fixed point of this fastening, and is locked on the upper end edge 10a of the solar panel 10.

Further, in the first rail portion 211, the windbreak wall 211b for preventing wind W1 from entering the rear surface 10d side with respect to the light-receiving surface 10c of the solar panel 10 as described above is provided with a cable-arrangement groove 211b-1 and a cable-arrangement tube 211b-2.

The cable-arrangement groove 211b-1 is a concave groove opening at an opposite side to the center side of the solar panel 10 seen from the windbreak wall 211b, and extending in the lateral array direction D3. A cable 252 to be connected to the solar panel 10 is allowed to be arranged inside the cable-arrangement groove 211b-1. As shown in FIG. 4, the cable 252 arranged inside of the cable-arrangement groove 211b-1 passes through a gap d between the first rail portions 211 adjacent to each other and reaches a rear surface side of the solar panel 10, and is connected to the solar panel 10.

The cable-arrangement tube 211b-2 is a tubular portion extending in the lateral array direction and opening at both ends. A cable 252 to be connected to the solar panel 10 is also allowed to be arranged inside the cable-arrangement tube 211b-2. This cable 252 arranged inside of the cable-arrangement tube 211b-2, similar to the cable 252 arranged inside of the cable-arrangement groove 211b-1, passes through a gap d between the first rail portions 211 adjacent to each other and reaches a rear surface side of the solar panel 10, and is connected to the solar panel 10.

In this embodiment, two cable-arrangement tubes 211b-2 are provided in two steps in a vertical direction from the weight-mounting plate 211a, and the one cable-arrangement groove 211b-1 is provided in the uppermost step. Further, in this embodiment, the cable-arrangement groove 211b-1 opening in the uppermost step is used as an arrangement place of the cable 252 to be connected to the output terminal of the solar panel 10.

Here, as shown in FIG. 5, the weight-mounting plate 211a of the first rail portion 211 extends toward an opposite side to the center side of the solar panel 10 seen from the windbreak wall 211. Further, the cable-arrangement groove 211b-1 is so positioned that the weight 230 reaches the cable-arrangement groove 211b-1 when the weight 230 is mounted on the weight-mounting plate 211a. In this embodiment, the weight 230 prevents the cable 252 arranged inside of the cable-arrangement groove 211b-1 from dropping out.

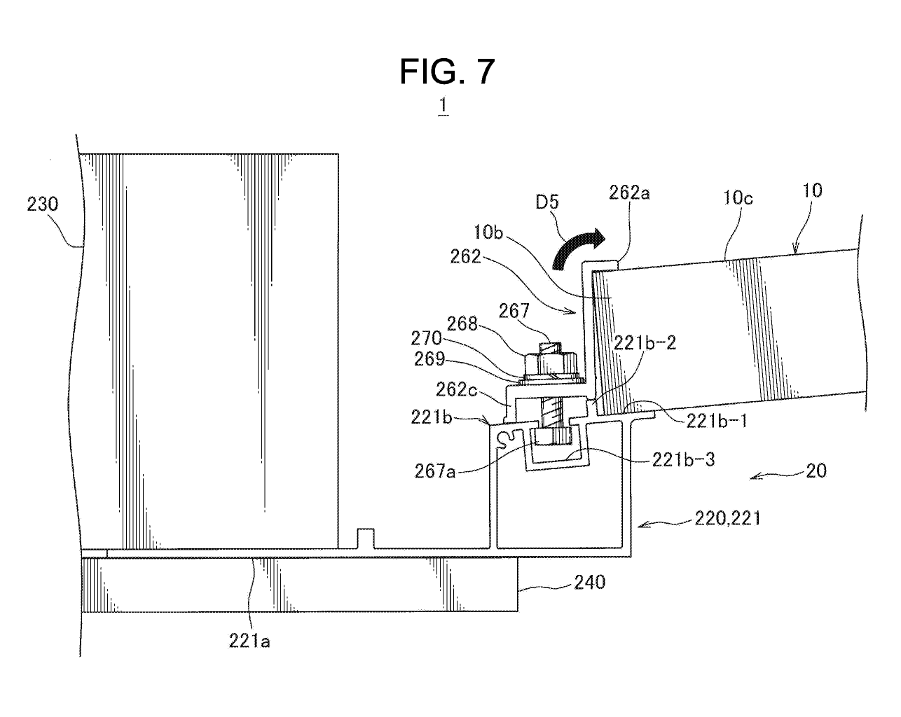

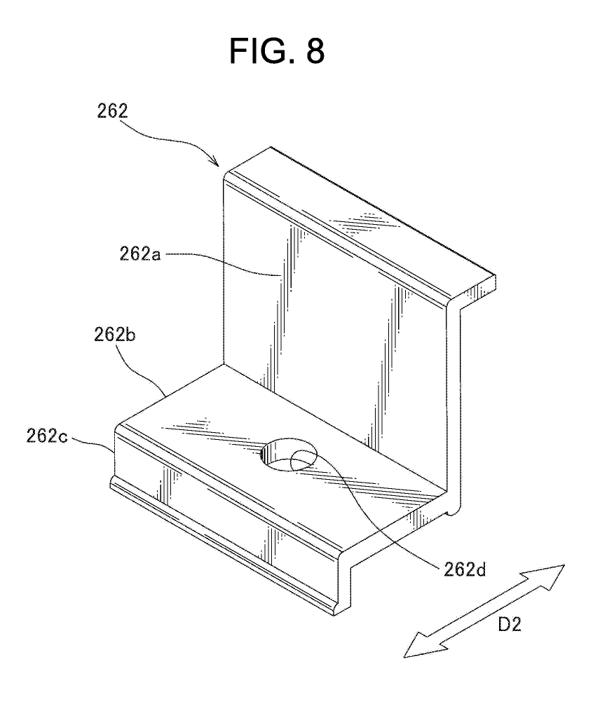

FIG. 7 is an enlarged view of an area A2 near a lower end edge of the solar panel in FIG. 2, and FIG. 8 is a perspective view showing a lower fixing bracket.

As shown in FIG. 7, the second rail portion 221 supporting the lower end edge 10b of the one solar panel 10 includes: a weight-mounting plate 221a on which the weight 230 is mounted; and a panel fixture 221b integrally provided with the weight-mounting plate 221a and to which the lower end edge 10b of the solar panel 10 is fixed. The weight-mounting plate 211a is put on the non-slip sheet 240 spread on the deck roof, and the weight 230 is mounted on the weight-mounting plate 221a extending along the deck roof. The panel fixture 221b is provided with a mounting surface 221b-1 on which the vicinity of the lower end edge 10b of the rear surface 10d as the installation location side of the solar plate 10 is mounted. A temporary support projection 221b-2 extends vertically from the mounting surface 221b-1 for temporarily supporting the lower end edge 10b of the solar panel 10 on the mounting surface 221b-1. The lower end edge 10b, of which vicinity is mounted on the mounting surface 221b-1, of the solar panel 10 abuts on the temporary support projection 221b-2, and the temporary support projection 221b-2 supports the lower end edge 10b due to this abutment. This temporary support projection 221b-2 is a convex stripe extending in a length direction of the second rail portion 221.

The lower end edge 10b of the solar panel 10 temporarily supported on the mounting surface 221b-1 by the temporary support projection 221b-2 is fixed to the panel fixture 221b of the second rail portion 221 with the lower fixing bracket 262. The mounting surface 221b-1 of the panel fixture 221b is provided with a fixing groove 221b-3 for fixing the lower fixing bracket 262 with a bolt 267 and a nut 268.

The vicinity of the lower end edge 10b of the solar panel 10 temporarily supported by the temporary support projection 221b-2 is held between the lower fixing bracket 262 and the mounting surface 221b-1 of the panel fixture 221b and fixed to the panel fixture 221b. Thereby, the lower fixing bracket 262 fixes the lower end edge 10b of the solar panel 10 to the panel fixture 221b, namely, the second rail portion 221.

This lower fixing bracket 262 includes: a locking portion 262a; a bracket fixture 262b; and a projection 262c. The locking portion 262a locks from the side surface except the abutment part on the temporary support projection 221b-2 to the light-receiving surface 10c side at the lower end edge 10b. The bracket fixture 262b extends from the locking portion 262a toward an opposite side to the lower end edge 10b, and is fixed to the second rail portion 221 at the fixed point in the middle of the extension.

The bracket fixture 262b is provided with a through hole 262d at the fixed point which is substantially center in the vertical array direction D2 when the lower fixing bracket 262 is attached to the second rail portion 221. As shown in FIG. 7, when the screw head 267a is fitted into the fixing groove 221b-3 of the second rail portion 221, a screw portion of the bolt 267 penetrates the through hole 262d. The penetrating screw portion is fastened with the nut 268 via a flat washer 269 and a spring washer 270. Due to this fastening with the nut 268, the bracket fixture 262b, namely, the lower fixing bracket 262 is fixed to the second rail portion 221.

The projection 262c of the lower fixing bracket 262 projects toward the second rail portion 221 from a position opposite to the locking portion 262a sandwiching the through hole 262d as the fixed point, and a tip of the projection 262c abuts on the second rail portion 221. Then, a projection length of the projection 262c makes the locking portion 262a inclined toward the mounting surface 221b-1 side centered on the through hole 262d as the fixed point and locked on the lower end edge 10b of the solar panel 10. After the tip in a projection direction of the projection 262c abuts on the second rail portion 221, the locking portion 262a is inclined toward the mounting surface 221b-1 side centered on the fixed point.

An installation of the solar power device 1 as explained above on the deck roof is done by a procedure as follows.

First, leaving away from the installation location, in a wide place easy to operate, each upper end edge 10a of six solar panels 10 is fixed to the first rail portion 211, and each lower end edge 10b is fixed to the second rail portion 221.

When seeing the solar panels 10, in the above operation, firstly the solar panels 10 are mounted on the first rail portions 211 and the second rail portions 221 arranged parallel to each other with a gap of one solar panel 10. Then, they are fixed with the upper fixing brackets 261 and the lower fixing brackets 262. At this time, the solar panel 10 is mounted such that the lower end edge 10b of the solar panel 10 abuts on the temporary support projection 221b-2 of the second rail portion 221. While the solar panel 10 is positioned due to such temporary support, the upper end edge 10a is fixed to the first rail portion 211 with the upper fixing bracket 261, and the lower end edge 10b is fixed to the second rail portion 221 with the lower fixing bracket 262. Incidentally, at this time, for stabilizing the first rail portion 211 and the second rail portion 221, the weights 230 are properly mounted on the weight-mounting plates 211a, 221a of the first and second rail portions 211, 221.

Then, the solar panels 10 are carried to the installation location on the deck roof together with the first and second rail portions 211, 221 to which the upper and lower end edges 10a, 10b are respectively fixed, and they are arranged in two rows in the vertical array direction and three columns in the lateral array direction. The non-slip sheets 240 are spread on the installation location prior to the arrangement of the solar panels 10. The solar panels 10 are arranged such that the first rail portions 211 and the second rail portions 221 are mounted on the non-slip sheets 240 spread on the installation location.

Due to this arrangement, three first rail portions 211 are arranged in the lateral array direction D3 with a gap d to compose the first rail 210, and three second rail portions 221 are arranged in the lateral array direction D3 with a gap d to compose the second rail 220. Further, upon this arrangement, the wiring operation of cables 250 is carried out such that each cable 250 is arranged inside of the cable-arrangement groove 211b-1 of the first rail portion 211, and extends via the gap d toward the rear surface of the solar panel 10, and is connected to output terminals.

After the arrangement of the solar panels 10 and the wiring operation of the cables 250, the weights 230 are mounted on the weight-mounting plates 211a of the first rail portions 211 and the weight-mounting plates 221a of the second rail portions 221. Thereby, the first and second rail portions 211, 221, namely, the first rail 210 and the second rail 220 are installed immovably, and the installation of the solar power device 1 is completed.

According to the solar panel support frame 20 and the solar power device 1 of this embodiment, the first rail portion 211 composing the first rail 210 supporting the upper end edge 10a in the inclination direction D1 of the solar panel 10 is provided with the windbreak wall 211b to prevent wind from entering the rear surface 10d side with respect to the light-receiving surface 10c of the solar panel 10. Thereby, the wind W1 is prevented from entering from the upper end edge 10a in the inclination direction D1 to the rear surface 10d side, this entrance is particularly concerned.

At this time, the windbreak wall 211b blocks the space between the upper end edge 10a of the solar panel 10 and the first rail 210. However, because the first rail 210 is divided to three first rail portions 211, and the solar panel 10 is installed per each first rail portion 211, the reduction of workability due to the windbreak wall is minimized. In this way, the solar panel support frame 20 and the solar power device 1 of this embodiment are a non-fix type solar panel support frame and a solar power device having increased resistance to wind without reducing workability.

Further, according to the solar panel support frame 20 and the solar power device 1 of this embodiment, per one solar panel 10, the first rail portion 211 composing the first rail 210 and second rail portion 221 composing the second rail 220 are provided one by one. Thereby, it is possible that in a place different from the installation location where the operation space is limited, the solar panel 10 is fixed to the first and second rail portions 211, 221, and the solar panel 10 already fixed to the first and second rail portions 211, 221 is carried to the installation location. Thus, according to the solar panel support frame 20 and the solar power device 1 of this embodiment, the workability of installing the solar panel 10 is further increased.

Further, according to the solar panel support frame 20 and the solar power device 1 of this embodiment, there is provided the cable-arrangement groove 211b-1 opening at an opposite side to the center side of the solar panel 10 seen from the windbreak wall 211b, and extending in the lateral array direction D3. Thereby, the cable 250 can be installed into the cable-arrangement groove 211b-1 while the cable 250 can be seen. Further, after the installation, the condition of the installed cable 250 can be confirmed visually.

Here, according to this embodiment, the cable-arrangement groove 211b-1 is so positioned that the weight 230 reaches the cable-arrangement groove 211b-1 when the weight 230 is mounted on the weight-mounting plate 221a. Then, the weight 230 prevents the cable 252 arranged inside of the cable-arrangement groove 211b-1 from dropping out. Thereby, the cable 252 can be arranged stably.

Further, according to the solar panel support frame 20 and the solar power device 1 of this embodiment, there is also provided the cable-arrangement tube 211b-2 of which inside the cable 252 can be arranged. Thereby, when there is a cable particularly hostile to be exposed to the surrounding environment, such a cable can be insulated from the surrounding environment by arranging the cable inside of the cable-arrangement tube 211b-2. Incidentally, in this embodiment, the cable 252 is only arranged inside of the above cable-arrangement groove 211b-1.

Further, according to the solar panel support frame 20 and the solar power device 1 of this embodiment, the temporary support projection 221b-2 for temporarily supporting the lower end edge 10b on the mounting surface 221b-1 prior to the fixation by the lower fixing bracket 262 is provided on the second rail 220 supporting the lower end edge 10b in the inclination direction D1 of the solar panel 10. The fixation by the lower fixing bracket 262 is carried out by holding the vicinity of the lower end edge 10b in between the lower fixing bracket 262 and the mounting surface 221b-1 to fix the lower fixing bracket 262 to the second rail portion 221. Before this fixation by the lower fixing bracket 262, and before the vicinity of the lower end edge 10b of the rear surface 10d at the installation location side of the solar panel 10 is mounted on the mounting surface 221b-1 of the second rail portion 221, the upper side of this mounting surface 221b-1 is open. Therefore, the above temporary support is carried out only by simply mounting the vicinity of the lower end edge 10b of the rear surface 10d of the solar panel 10 on the mounting surface 221b-1 of the second rail portion 221, and by the lower end edge 10b abutting on the temporary support projection 221b-2. Further, the subsequent fixation by the lower fixing bracket 262 is carried out only by simply overlapping the lower fixing bracket 262 with the vicinity of the temporarily supported lower end edge 10b, and by fixing to the second rail portion 221 with a bolt 267 or the like. Such a temporary support and the fixation by the lower fixing bracket 262 can be easily carried out even if the working space is narrow. That is, according to the solar panel support frame 20 and the solar power device 1 of this embodiment, the solar panel 10 can be easily installed even if the working space is narrow.

Further, according to the solar panel support frame 20 and the solar power device 1 of this embodiment, because the temporary support projection 221b-2 is a convex stripe extending vertically and extending in a length direction of the second rail portion 221, the stability of the temporary support of the lower end edge 10b of the solar panel 10 is improved.

Further, according to the solar panel support frame 20 and the solar power device 1 of this embodiment, due to the projection 262c included by the lower fixing bracket 262, the locking portion 262a of the lower fixing bracket 262 is inclined toward the mounting surface 221b-1 side, and locked on the lower end edge 10b of the solar panel 10. Thereby, the fixation strength of the lower end edge 10b of the solar panel 10 by the lower fixing bracket 262 is improved.

Incidentally, the above explained embodiments only illustrate a typical form of the present invention, and the present invention is not limited to these embodiments. Namely, various modifications can be practiced within a scope of the present invention. Of course, these modifications are included in the category of the present invention as long as they are equipped with the configuration of the solar panel support frame and the solar power device of the present invention.

For example, in the above embodiment, as one example of the solar panel support frame and the solar power device, the solar panel support frame 20 and the solar power device 1 supporting the six solar panels 10 arranged in three rows and three columns are illustrated. However, the solar panel support frame and the solar power device of the present invention are not limited to this. The specific number or the specific array of solar panels is no object.

Further, in the above embodiment, as one example of the solar panel support frame and the solar power device, in the solar panel support frame 20 and the solar power device 1, the mounting surface 221b-1 of the second rail portion 221, on which the vicinity of the lower end edge 10b of the rear surface 10d of the solar panel 10 is mounted, is configured with a flat surface is illustrated. However, the solar panel support frame and the solar power device of the present invention are not limited to this. For example, the mounting surface may be formed by an assembly of the tips of plurality of projections arranged in teeth of a comb shape. The specific configuration of the mounting surface on which the vicinity of the lower end edge is mounted at the installation location side is no object as long as the mounting is allowed.

Further, in the above embodiment, the solar panel 10 having a rectangular shape in a plan view is illustrated as an example of the solar panel of the present invention. However, the solar panel of the present invention is not limited to this. The specific shape of the solar panel is no object as long as the upper and lower end edges are provided in the inclination direction when arranged in an inclined manner.

Further, in both of the above two embodiments, as an example of the installation location of the present invention, the deck roof is illustrated. However, the installation location of the present invention is not limited to this. As long as a flat installation location, it may be an outdoor flat ground or the like.

### REFERENCE SIGNS LIST

1 solar power device
10 solar panel
10a upper end edge
10b lower end edge
20 solar power support frame
210 first rail
211 first rail portion
211a weight-mounting plate
211b windbreak wall
211b-1 cable-arrangement groove
211b-2 cable-arrangement tube
211c panel fixture
220 second rail
221 second rail portion
221b-1 mounting surface
221b-2 temporary support projection
230 weight
240 non-slip sheet
250 cable
261 upper fixing bracket
261a, 262a locking portion
261b, 262b bracket fixture
262 lower fixing bracket
D1 inclination direction
D2 vertical array direction
D3 lateral array direction
W1 wind
d gap

1. A solar panel support frame for installing a plurality of solar panels each disposed in an inclined pose in an inclination direction relative to a flat installation location, and arranged in an array direction crossing the inclination direction of the solar panel and along the installation location, said solar panel support frame comprising:
a first rail extending in the array direction and supporting an upper end edge in the inclination direction of the solar panel;
a second rail extending in the array direction and parallel to the first rail, and supporting a lower end edge in the inclination direction of the solar panel; and
a weight installing immovably any one or both of the first and second rails on the installation location due to its weight,
wherein the first rail is made of a plurality of first rail portions arranged in the array direction with a gap shorter than each first rail portion, and each first rail portion is longer than a half width in the array direction of the solar panel, and
wherein the first rail portion includes:
a weight-mounting plate extending along the installation location and on which the weight is mounted;
a windbreak wall extending vertically from the weight-mounting plate and preventing wind from entering a rear surface side relative to a light-receiving surface of the solar panel; and
a panel fixture provided on an upper end edge of the windbreak wall and fixing the upper end edge of the solar panel.

2. The solar panel support frame as claimed in claim 1,
wherein the second rail is made of a plurality of second rail portions arranged in the array direction, and each second rail portion is substantially equal to or longer than the half width in the array direction of the solar panel,
wherein a length of the first rail portion is substantially equal to the half width in the array direction of the solar panel, and
wherein each single solar panel is provided with the one first rail portion, and with one or a plurality of the second rail portions.

3. The solar panel support frame as claimed in claim 1,
wherein the windbreak wall is provided with a cable-arrangement groove as a concave groove opening in an opposite side to the center side of the solar panel seen from the windbreak wall and extending in the array direction, and into which a cable to be connected to the solar panel is allowed to be arranged, and
wherein the cable arranged inside of the cable-arrangement groove is connected to the solar panel in a manner passing through a gap between the first rail portions to reach the rear surface side of the solar panel.

4. The solar panel support frame as claimed in claim 2,
wherein the windbreak wall is provided with a cable-arrangement groove as a concave groove opening in an opposite side to the center side of the solar panel seen from the windbreak wall and extending in the array direction, and into which a cable to be connected to the solar panel is allowed to be arranged, and
wherein the cable arranged inside of the cable-arrangement groove is connected to the solar panel in a manner passing through a gap between the first rail portions to reach the rear surface side of the solar panel.

5. The solar panel support frame as claimed in claim 1,
wherein the windbreak wall is provided with a cable-arrangement tube as a tubular portion extending in the array direction and opening at both ends, and into which a cable to be connected to the solar panel is allowed to be arranged, and
wherein the cable arranged inside of the cable-arrangement tube is connected to the solar panel in a manner passing through a gap between the first rail portions to reach the rear surface side of the solar panel.

6. The solar panel support frame as claimed in claim 2,
wherein the windbreak wall is provided with a cable-arrangement tube as a tubular portion extending in the array direction and opening at both ends, and into which a cable to be connected to the solar panel is allowed to be arranged, and
wherein the cable arranged inside of the cable-arrangement tube is connected to the solar panel in a manner passing through a gap between the first rail portions to reach the rear surface side of the solar panel.

7. The solar panel support frame as claimed in claim 3,
wherein the windbreak wall is provided with a cable-arrangement tube as a tubular portion extending in the array direction and opening at both ends, and into which a cable to be connected to the solar panel is allowed to be arranged, and
wherein the cable arranged inside of the cable-arrangement tube is connected to the solar panel in a manner passing through a gap between the first rail portions to reach the rear surface side of the solar panel.

8. The solar panel support frame as claimed in claim 4,
wherein the windbreak wall is provided with a cable-arrangement tube as a tubular portion extending in the array direction and opening at both ends, and into which a cable to be connected to the solar panel is allowed to be arranged, and
wherein the cable arranged inside of the cable-arrangement tube is connected to the solar panel in a manner passing through a gap between the first rail portions to reach the rear surface side of the solar panel.

9. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 1.

10. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 2.

11. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 3.

12. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 4.

13. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 5.

14. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 6.

15. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 7.

16. A solar power device comprising:
a plurality of solar panels; and
a solar panel support frame for installing a plurality of solar panels each disposed in an inclined pose in an inclination direction relative to a flat installation location, and arranged in an array direction crossing the inclination direction of the solar panel and along the installation location,
wherein the solar panel support frame is the solar panel support frame claimed in claim 8.
